(19) United States
(12) Patent Application Publication
(10) Pub. No.: US 2003/0023655 A1
(43) Pub. Date: Jan. 30, 2003

(54) Method and apparatus to facilitate suspending threads in a platform-independent virtual machine

(76) Inventors: Stepan Sokolov, Fremont, CA (US); David Wallman, Sunnyvale, CA (US)

Correspondence Address: PARK, VAUGHAN & FLEMING LLP, 508 SECOND STREET, SUITE 201, DAVIS, CA, 95616, US

(21) Appl. No.: 09/917,525

(22) Filed: Jul. 26, 2001

(51) Int. Cl. G06F 17/00

(52) U.S. Cl. 709/1

(57) ABSTRACT

One embodiment of the present invention provides a system that facilitates suspending threads in a platform-independent virtual machine implemented on an operating system that lacks a global mechanism for suspending threads. The system operates when the platform-independent virtual machine executes a thread requiring other threads to be suspended. The system first changes the scheduling policy for the thread, and then raises the priority of the thread to the highest available priority. Changing the scheduling policy and raising the priority of the thread causes the thread to run to completion while other threads do not run.

### BACKGROUND

1. Field of the Invention

The present invention relates to computer programs. More specifically, the present invention relates to a method and an apparatus to facilitate suspending threads of execution in a platform-independent virtual machine.

2. Related Art

Computer programs written in languages such as JAVA™ are compiled into a platform-independent code, which is executed on a platform-independent virtual machine, such as a JAVA VIRTUAL MACHINE (JVM). A program that has been compiled into a platform-independent code has the advantage that it can execute on a platform-independent virtual machine regardless of the underlying central processing unit and native code. The terms JAVA, JVM, JAVA VIRTUAL MACHINE, and Solaris are trademarks of SUN Microsystems, Inc. of Palo Alto, Calif.

Typically, the platform-independent virtual machine uses the services of a computer operating system running on the computing system for input/output, memory allocation, thread scheduling, and the like. Well-known examples of computer operating systems include Solaris™ and universal interactive executive (UNIX). To enable thread support on UNIX, implementers typically use portable operating system for UNIX (POSIX). While these operating systems include the same basic services to the platform-independent machine, there are differences, which make some operating systems less than ideal. For example, the Pthreads application programming interface (API) of POSIX lacks the functionality to suspend all of the threads but one, while Solaris™ includes such functionality.

A platform-independent virtual machine must, at times, suspend all threads except one in order to function correctly. One case where this is true is for garbage collection. During garbage collection, all threads, with the exception of the garbage collection thread, must be suspended so that the contents of memory do not change during the garbage collection cycle.

Since the Pthreads API does not include the functionality to suspend all but one thread, implementers have established a workaround to be able to suspend all but one thread. This workaround includes using the UNIX signal system to send a user-defined signal to the platform-independent virtual machine's processes. In response to this user defined signal, the process halts the current threads and waits for another signal to resume. While the threads are halted, the garbage collection, or other uninterruptible task runs to completion. This technique achieves what is required. However, it comes at a high price in terms of execution time and can additionally pose synchronization problems.

What is needed is a method and an apparatus, which allows all threads but one to be suspended while the one thread runs to completion, and which does not have the problems listed above.

### SUMMARY

One embodiment of the present invention provides a system that facilitates suspending threads in a platform-independent virtual machine implemented on an operating system that lacks a global mechanism for suspending threads. The system operates when the platform-independent virtual machine executes a thread requiring other threads to be suspended. The system first changes the scheduling policy for the thread, and then raises the priority of the thread to the highest available priority. Changing the scheduling policy and raising the priority of the thread causes the thread to run to completion while other threads do not run.

In one embodiment of the present invention, upon completion of the thread, the system reduces the priority of the thread to its assigned priority, and returns the scheduling policy of the thread to its assigned scheduling policy.

In one embodiment of the present invention, the thread requiring other threads to be suspended includes a garbage collection thread.

In one embodiment of the present invention, changing the scheduling policy for the thread includes changing the scheduling policy from round-robin to first-in-first-out (FIFO).

In one embodiment of the present invention, the operating system that lacks the global mechanism for suspending threads includes POSIX.

In one embodiment of the present invention, the platform-independent virtual machine includes a JAVA VIRTUAL MACHINE™.

In one embodiment of the present invention, the system performs a garbage collection with the thread.

### BRIEF DESCRIPTION OF THE FIGURES

FIG. 1 illustrates computing device 102 in accordance with an embodiment of the present invention.

FIG. 2 illustrates platform-independent virtual machine 104 coupled to computer operating system 114 in accordance with an embodiment of the present invention.

FIG. 3 is a flowchart illustrating the process of performing an uninterruptible process in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computing Device

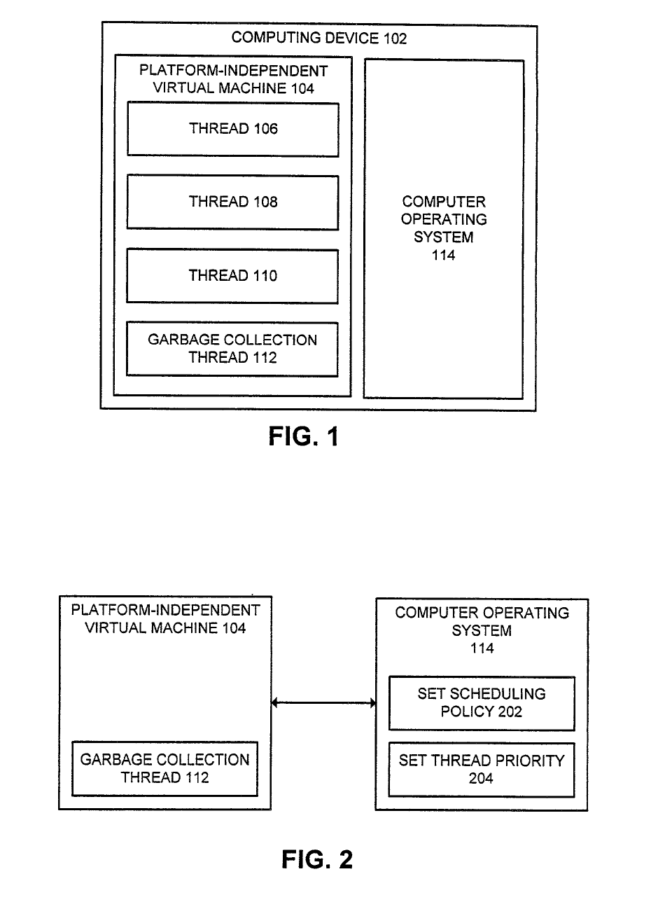

FIG. 1 illustrates computing device 102 in accordance with an embodiment of the present invention. Computing device 102 can generally include any type of computer system, including, but not limited to, a computer system based on a microprocessor, a mainframe computer, a digital signal processor, a portable computing device, a personal organizer, a device controller, and a computational engine within an appliance. Computing device 102 includes platform-independent virtual machine 104 and computer operating system 114.

Computer operating system 114 provides services to platform-independent virtual machine 104 including input/output, memory allocation, thread scheduling, and the like. In one embodiment of the present invention, computer operating system 114 includes the universal interactive executive (UNIX) with the portable operating system for UNIX (POSIX) application programming interface (API). Platform-independent virtual machine 104 includes threads 106, 108, and 110, and garbage collection thread 112. Threads 106, 108, and 110 are the various threads of execution of a program being executed by platform-independent virtual machine 104. Note that the number of threads is determined by the program being executed and may include more or less threads than shown in FIG. 1.

Garbage collection thread 112 periodically reclaims memory that was used by one of the threads within platform-independent virtual machine 104 and is no longer in use. Garbage collection is well known in the art and will not be discussed further herein. Garbage collection thread 112 is representative of a thread within platform-independent virtual machine 104, which should not be interrupted once it is started. Interrupting garbage collection thread 112 may lead to memory corruption if memory is changed while garbage collection thread 112 is interrupted. There may also be other threads executing on platform-independent virtual machine 104, which should not be interrupted once they are started.

Coupling Between Modules

FIG. 2 illustrates platform-independent virtual machine 104 coupled to computer operating system 114 in accordance with an embodiment of the present invention. Computer operating system 114 includes set scheduling policy 202 and set thread priority 204. When garbage collection thread 112 is scheduled to run, platform-independent virtual machine 104 uses set scheduling policy 202 and set thread priority 204 to change the scheduling policy and thread priority of garbage collection thread 112 to ensure that garbage collection thread 112 runs to completion before other threads are allowed to run. Upon completion of garbage collection thread 112, platform-independent virtual machine 104 uses set scheduling policy 202 and set thread priority 204 to return the scheduling policy and priority of garbage collection thread 112 to its normally assigned scheduling policy and priority.

Set scheduling policy 202 can be implemented as a POSIX call which can change the scheduling policy from round-robin to first-in, first-out and back. An example of the POSIX call, which will change the scheduling policy is: “pthread_setsehedparam(tid, SCHED_FIFO, &param)” where tid is the thread identifier and param is a pointer to a list of parameters. Typically, garbage collection thread 112 is assigned to the round-robin scheduling policy. Changing the scheduling policy to first-in, first-out ensures that garbage collection thread 112 is not interrupted by a thread with equal or lower priority. Set thread priority 204 is used to set the priority of garbage collection thread 112 to the highest priority available, thereby ensuring that, once started, garbage collection thread 112 runs to completion while all other threads are prevented from running. The statement to change the priority of a thread is “param.sched_priority=priority” where priority is the newly assigned priority. Note that while this discussion centers on garbage collection thread 112, the same principles can be applied to any thread, which must run to completion without being interrupted. Upon completion, the priority of garbage collection thread 112 is returned to the assigned priority.

Performing an Uninterruptible Process

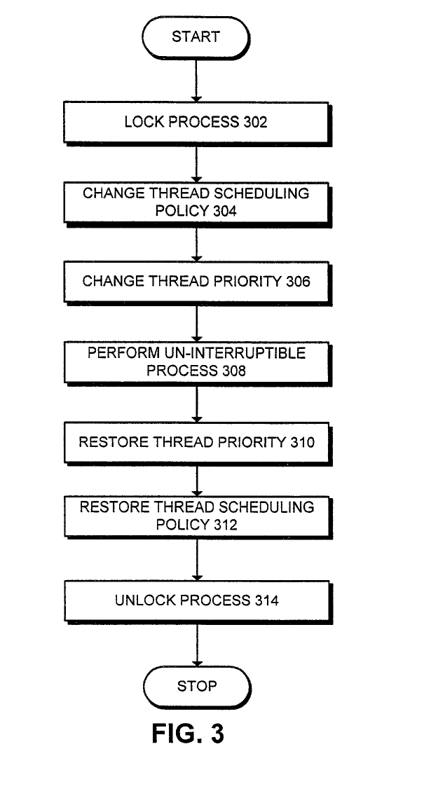

FIG. 3 is a flowchart illustrating the process of performing an uninterruptible process in accordance with an embodiment of the present invention. The system starts when platform-independent virtual machine 104 locks garbage collection thread 112 (step 302). Next, platform-independent virtual machine 104 calls set scheduling policy 202 within computer operating system 114 to change the scheduling policy of garbage collection thread 112 from round-robin to first-in, first-out (step 304). Platform-independent virtual machine 104 then changes the priority of garbage collection thread 112 to the highest priority available. (step 306).

After platform-independent virtual machine 104 has set the scheduling policy and priority of garbage collection thread 112, platform-independent virtual machine 104 allows garbage collection thread 112 to run (step 308). Garbage collection thread 112 runs to completion, while all other threads are prevented from running. Note that the same process can be applied to any thread, which requires that other threads do not run while that thread is being executed.

When garbage collection thread 112 has run to completion, platform-independent virtual machine 104 calls set thread priority 204 to restore garbage collection thread 112 to its assigned priority (step 310). Next, platform-independent virtual machine 104 calls set scheduling policy 202 to restore garbage collection thread 112 to its assigned scheduling policy (step 312). Finally, platform-independent virtual machine 104 unlocks garbage collection thread 112 (step 314).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method to facilitate suspending threads in a platform-independent virtual machine implemented on an operating system that lacks a global mechanism for suspending threads, comprising:
executing a thread requiring other threads to be suspended;
changing a scheduling policy for the thread; and
raising a priority of the thread to a highest available priority, whereby changing the scheduling policy and raising the priority of the thread causes the thread to run to completion while other threads do not run.

2. The method of claim 1, further comprising:
upon completion of the thread,
reducing the priority of the thread to an assigned priority; and
returning the scheduling policy of the thread to an assigned scheduling policy.

3. The method of claim 1, wherein the thread requiring other threads to be suspended includes a garbage collection thread.

4. The method of claim 1, wherein changing the scheduling policy for the thread includes changing the scheduling policy from round-robin to first-in, first-out.

5. The method of claim 1, wherein the operating system that lacks the global mechanism for suspending threads includes POSIX.

6. The method of claim 1, wherein the platform-independent virtual machine includes a JAVA VIRTUAL MACHINE™.

7. The method of claim 1, further comprising performing a garbage collection with the thread.

8. A computer-readable storage medium storing instructions that when executed by a computer cause the computer to perform a method to facilitate suspending threads in a platform-independent virtual machine implemented on an operating system that lacks a global mechanism for suspending threads, the method comprising:
executing a thread requiring other threads to be suspended;
changing a scheduling policy for the thread; and
raising a priority of the thread to a highest available priority, whereby changing the scheduling policy and raising the priority of the thread causes the thread to run to completion while other threads do not run.

9. The computer-readable storage medium of claim 8, the method further comprising:
upon completion of the thread,
reducing the priority of the thread to an assigned priority; and
returning the scheduling policy of the thread to an assigned scheduling policy.

10. The computer-readable storage medium of claim 8, wherein the thread requiring other threads to be suspended includes a garbage collection thread.

11. The computer-readable storage medium of claim 8, wherein changing the scheduling policy for the thread includes changing the scheduling policy from round-robin to first-in, first-out.

12. The computer-readable storage medium of claim 8, wherein the operating system that lacks the global mechanism for suspending threads includes POSIX.

13. The computer-readable storage medium of claim 8, wherein the platform-independent virtual machine includes a JAVA VIRTUAL MACHINE™.

14. The computer-readable storage medium of claim 8, the method further comprising performing a garbage collection with the thread.

15. An apparatus that facilitates suspending threads in a platform-independent virtual machine implemented on an operating system that lacks a global mechanism for suspending threads, comprising:
an executing mechanism that is configured to execute a thread requiring other threads to be suspended;
a changing mechanism that is configured to change a scheduling policy for the thread; and
a priority raising mechanism that is configured to raise a priority of the thread to a highest available priority, whereby changing the scheduling policy and raising the priority of the thread causes the thread to run to completion while other threads do not run.

16. The apparatus of claim 15, further comprising:
a priority reducing mechanism that is configured to reduce the priority of the thread to an assigned priority; and
a returning mechanism that is configured to return the scheduling policy of the thread to an assigned scheduling policy.

17. The apparatus of claim 15, wherein the thread requiring other threads to be suspended includes a garbage collection thread.

18. The apparatus of claim 15, wherein changing the scheduling policy for the thread includes changing the scheduling policy from round-robin to first-in, first-out.

19. The apparatus of claim 15, wherein the operating system that lacks the global mechanism for suspending threads includes POSIX.

20. The apparatus of claim 15, wherein the platform-independent virtual machine includes a JAVA VIRTUAL MACHINE™.

21. The apparatus of claim 15, further comprising a garbage collection mechanism that is configured to perform a garbage collection with the thread.
